(19) United States
(12) Patent Application Publication
(10) Pub. No.: US 2005/0147022 A1
(43) Pub. Date: Jul. 7, 2005

(54) Preamble transmit power tailoring system, a method of tailoring preamble transmit power and an OFDM transmitter employing the same

(75) Inventors: Srinath Hosur, Plano, TX (US); Srikanth Gummadi, Rohnert Part, CA (US); Anuj Batra, Dallas, TX (US); Michael Oliver Polley, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/744,147

(22) Filed: Dec. 22, 2003

(51) Int. Cl. H04J 11/00

(52) U.S. Cl. 370/203

(57) ABSTRACT

A preamble transmit power tailoring system for use with an Orthogonal Frequency Division Multiplexing (OFDM) transmitter, a method of tailoring preamble transmit power, and an OFDM transmitter. In one embodiment, the preamble transmit power tailoring system includes (1) a peak power estimator configured to calculate, based on a payload to be transmitted by the OFDM transmitter and an associated transmit power limitation value, an available power headroom and (2) a preamble power enhancer, associated with the peak power estimator, configured to increase transmit power of at least a portion of a preamble for the payload subject to the available power headroom.

### TECHNICAL FIELD OF THE INVENTION

The present invention is directed, in general, to a communications system and, more specifically, to an Orthogonal Frequency Division Multiplexing (OFDM) communications system employing a preamble transmit power tailoring system, a method of tailoring preamble transmit power and an OFDM transmitter employing the same.

### BACKGROUND OF THE INVENTION

The use of wireless communications continues to expand with the development of wireless devices and the improvement of wireless communications systems. More users are exchanging information through pagers, cellular telephones, and other wireless communication products. Additionally, wireless communications allows users to exchange information in personal and business computing through wireless networks such as a wireless local area network (WLAN). A WLAN provides flexibility and mobility for users by enabling access to computer networks without being tied to wired networks.

Several protocols have been created to provide standards and encourage growth in the development of wireless networks. One such protocol provided by the Institute of Electrical and Electronic Engineers (IEEE) is known as IEEE 802.11. 802.11 refers to a family of specifications that have been developed for WLAN technology.

Generally, 802.11 specifies an over-the-air interface between a wireless client and a base station or between two wireless clients. Included within the 802.11 family, there are several specifications covering different transmission rates, encoding schemes and frequency bands for transmitting data wirelessly. For example, 802.11a is an extension of 802.11 that specifically addresses WLANs having a data rate up to 54 Mbps at a frequency band of 5 GHz. Unlike 802.11, 802.11a specifies an OFDM encoding scheme. Additionally, 802.11g specifies an OFDM encoding scheme for the 2.4 GHz frequency band.

OFDM systems specified in 802.11a/g are packet based communications systems that provide a WLAN with data communication capabilities of 6, 9, 12, 18, 24, 36, 48, and 54 Mbit/s. The packet in the OFDM systems includes a preamble and a payload. The payload is the data to be transmitted through a wireless channel. The preamble, attached to the payload, is designed to provide functionality for the OFDM systems, such as, assisting in detecting the packet and estimating the wireless channel used for transmission.

The OFDM systems may be single-input single-output (SISO) communications systems or multiple-input multiple-output (MIMO) communications systems. A MIMO communications system may provide an improvement in capacity and reliability over a SISO communications system. 802.11a/g OFDM systems, whether SISO or MIMO, may use 52 subcarriers that are modulated using binary or quadrature phase shift keying (BPSK/QPSK), 16-quadrature amplitude modulation (QAM), or 64-QAM depending on the data rate required. Of course, other OFDM systems may use more or even less subcarriers.

The multiple subcarriers of the OFDM systems may provide several benefits. For example, the OFDM systems typically provide sufficient impulse noise immunity and resistance to inter-symbol interference (ISI) without extensive equalization. A problem associated with the multiple subcarriers of the OFDM systems, however, is constructive addition of high amplitude peaks of tones associated with the subcarriers. When compared to an average transmitting power for a packet, instantaneous power of the additive peaks is high resulting in a high peak-to-average power ratio (PAR). The PAR for data is defined as the maximum peak instantaneous power over a certain window of data divided by the average power.

Typically, a power amplifier (PA) of a transmitter in the OFDM systems has an input/output compression point below which the input power to output power gain is close to linear. If the input power is higher than the compression point, the power gain of the PA is non-linear resulting in clipping and other adverse non-linear signal effects. To maintain a fairly linear signal, a backoff is selected from the compression point and the PA is operated at a backoff value such that the average input power of the data is at the selected backoff value. Thus, the nonlinear effects in the signal will have a minimal impact when the peak power of the data exceeds the average power up to the backoff value.

A power amplifier of a OFDM transmitter, therefore, is typically operated with a backoff from its compression point in order to minimize the non-linear distortion effects of the PA. Though a PAR of the preamble is typically less than a PAR of the payload, the backoff affects average transmit power of both the preamble and the payload. This results in a lower preamble transmit power that may adversely affect channel estimation and packet detection at a OFDM receiver. This is especially difficult in MIMO systems which are more sensitive to channel estimation errors.

Accordingly, what is needed in the art is an OFDM transmitter that provides improved channel estimation while satisfying regulatory standards for transmitting power.

### SUMMARY OF THE INVENTION

To address the above-discussed deficiencies of the prior art, the present invention provides a preamble transmit power tailoring system for use with an Orthogonal Frequency Division Multiplexing (OFDM) transmitter, a method of tailoring preamble transmit power, and an OFDM transmitter. In one embodiment, the preamble transmit power tailoring system includes (1) a peak power estimator configured to calculate, based on a payload to be transmitted by the OFDM transmitter and an associated transmit power limitation value, an available power headroom and (2) a preamble power enhancer, associated with the peak power estimator, configured to increase transmit power of at least a portion of a preamble for the payload subject to the available power headroom.

The present invention advantageously recognizes and employs a transmitting power overhead that is used to increase transmit power for the preamble. Since a PAR of the preamble (preamble PAR) is typically less than a PAR of the payload (payload PAR), the present invention may tailor the transmit power of the preamble to transmit the preamble at a higher average power compared to the payload by taking advantage of the available power headroom. A difference in the transmit power limitation value and the preamble PAR can be used to determine the available power headroom. The available power headroom may only be determined based on a portion of the preamble. Furthermore, the transmit power may be increased for only a portion of the preamble or for the entirety of the preamble. The transmit power limitation value, which may be a backoff value associated with the compression point of a power amplifier, is typically a function of the payload PAR and a performance criterion. The higher preamble transmit power may provide improved functionality associated with the preamble, such as, channel estimation and packet detection.

In another aspect, the present invention provides a method of tailoring preamble transmit power for use with an OFDM transmitter. The method includes (1) calculating an available power headroom based on a payload to be transmitted by the OFDM transmitter and an associated transmit power limitation value and (2) providing a transmit power for at least a portion of a preamble of the payload subject to the available power headroom.

In yet another aspect, the present invention provides a an OFDM transmitter including (1) a Forward Error Correction (FEC) coder that encodes a payload received by the OFDM transmitter, (2) OFDM transmission circuitry, coupled to the FEC coder, that processes the payload for wireless transmission, (3) a power amplifier, coupled to the OFDM transmission circuitry, that boosts power of the payload for the wireless transmission over a channel, and (4) a preamble transmit power tailoring system associated with the power amplifier. The preamble transmit power tailoring system includes (4a) a peak power estimator configured to calculate, based on the payload and an associated transmit power limitation value, an available power headroom and (4b) a preamble power enhancer, associated with the peak power estimator, configured to increase transmit power of at least a portion of a preamble for the payload subject to the available power headroom.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of an OFDM transmitter constructed according to the principles of the present invention;

FIG. 2 illustrates a block diagram of an embodiment of an preamble transmit power tailoring system constructed according to the principles of the present invention; and

FIG. 3 illustrates an embodiment of a flow diagram for a method of tailoring a preamble transmit power for use with an OFDM transmitter carried out according to the principles of the present invention.

### DETAILED DESCRIPTION

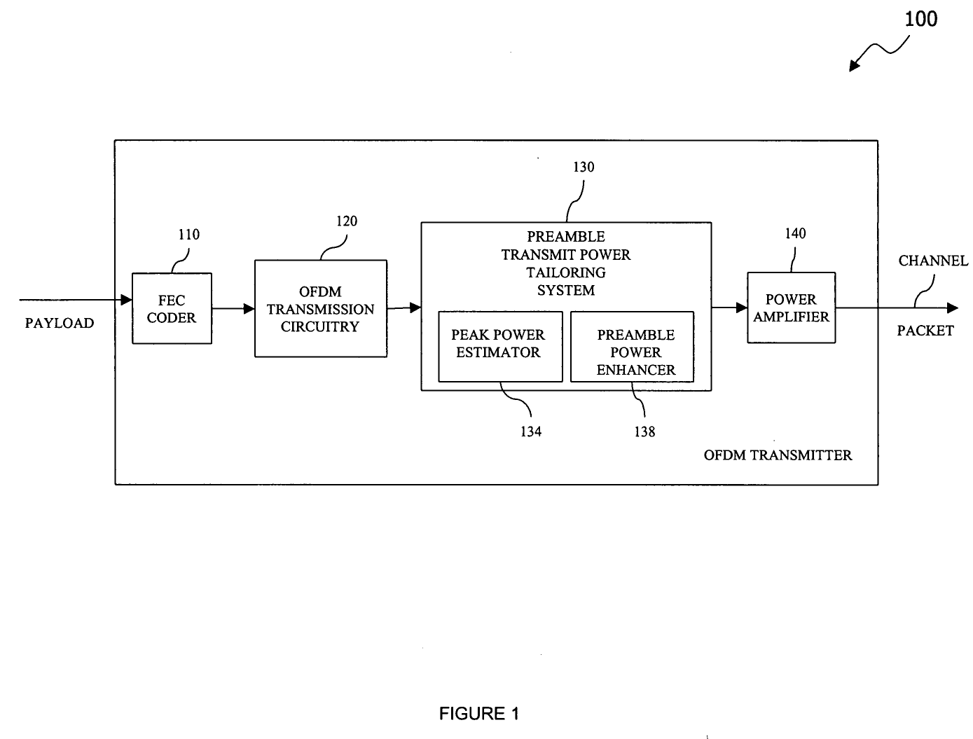

Referring initially to FIG. 1, illustrated is a block diagram of an embodiment of an OFDM transmitter, generally designated 100, constructed according to the principles of the present invention. The OFDM transmitter 100 includes a Forward Error Correction (FEC) coder 110, OFDM transmission circuitry 120, a preamble transmit power tailoring system 130 and a power amplifier 140. The preamble transmit power tailoring system 130 includes a peak power estimator 134 and a preamble power enhancer 138.

The OFDM transmitter 100 may be configured to wirelessly transmit a packet, including a preamble and a payload, to an OFDM receiver. The OFDM transmitter 100 may be employed within a wireless local area network (WLAN). For example, the OFDM transmitter 110 may be an access point. Additionally, the OFDM transmitter 100 may be a card or circuit employed in a laptop computer, a point-of-sale terminal or a personal digital assistant. The OFDM transmitter 100 may be a single-input single-output (SISO) transmitter or may be a multiple-input multiple-output (MIMO) transmitter. Portions of the OFDM transmitter 100 may be embodied, without limitations, within an Application Specific Integrated Circuit (ASIC), or in a programmable device such as a Field Programmable Gate Array (FPGA) or a Digital Signal Processor (DSP).

The FEC coder 110 may encode the payload received by the OFDM transmitter 100 for transmission to the OFDM receiver. The payload may be digital data received from a computer system coupled to the OFDM transmitter 100. The FEC coder 110 may employ a block-based coding scheme, such as Reed-Solomon, or a convolutional coding scheme, such as Viterbi decoding, to provide an encoded payload. Of course, additional coding schemes may also be employed, such as, concatenated coding, turbo codes, Low Density Parity Check (LDPC) codes, etc.

The OFDM transmission circuitry 120, coupled to the FEC coder 110, processes the encoded payload for wireless transmission. The OFDM transmission circuitry 120 may include conventional components commonly located within an OFDM transmitter. For example, the OFDM transmission circuitry 120 may include a data processor that prepares the encoded payload for the wireless transmission over a channel. The data processor may encode, interleave, map for transmission and convert the encoded payload to a time-domain employing an Inverse Fast Fourier Transform (IFFT) algorithm. The data processor may shape and modulate the encoded payload for transmission employing binary or quadrature phase shift keying (BPSK/QPSK), 16-quadrature amplitude modulation (QAM), or 64-QAM, depending on a required data rate. Additionally, the data processor may insert a guard interval/cyclic prefix. One skilled in the art will understand the configuration and operation of the OFDM transmission circuitry 120.

The preamble transmit power tailoring system 130, associated with the OFDM transmission circuitry 120, intelligently tailors a transmitting power of the preamble to improve functionality associated with the preamble at the receiver. The preamble transmit power tailoring system 130 may be a separate component of the OFDM transmitter 100. In some embodiments, a portion of the preamble transmit power tailoring system 130 may be employed within the OFDM transmission circuitry 120 or the power amplifier 140. The preamble transmit power tailoring system 130 may be embodied as a sequence of operating instructions, dedicated hardware or a combination thereof.

The peak power estimator 134 is configured to calculate, based on the payload and an associated transmit power limitation value, an available power headroom. The peak power estimator 134 can calculate the available power headroom by determining the difference between the transmit power limitation value and a preamble PAR. In some embodiments, the peak power estimator 134 may determine the available power headroom based on a portion of the preamble. The peak power estimator 134 can determine the portion dynamically or statically. Thus, which portion of the preamble that may be used may be pre-determined.

Typically, the transmit power limitation value is a function of a payload PAR and one or more performance criterions. The peak power estimator 134 may dynamically determine the payload PAR for calculating the transmit power limitation value. Alternatively, the peak power estimator 134 may determine the payload PAR statically. The peak power estimator 134 may also dynamically or statically determine the preamble PAR.

In addition to determining the payload PAR, the peak power estimator 134 is configured to calculate the transmit power limitation value. In some embodiments, the peak power estimator 134 may determine the transmit power limitation value on a packet by packet basis. In other embodiments, the peak power estimator 134 may determine the transmit power limitation value at one time for all packets to be transmitted.

One of the performance criterions that may be employed by the peak power estimator 134 to determine the transmit power limitation value is a bit error rate (BER). The transmit power limitation value may also be based on a regulatory standard imposed on wireless transmission communications systems. For example, the transmit power limitation value may be based on a Federal Communication Commission (FCC) standard that is incorporated in the 802.11a or the 802.11g specification.

Typically, the transmit power limitation value is a backoff value associated with a compression point of the power amplifier 140. The backoff value is usually a backoff value associated with the payload. The peak power estimator 134 may determine the backoff value based on statistical characterization of a DAT and performance achieved for various backoff levels. The peak power estimator 134 may also determine and set the backoff value in a calibration phase of the power amplifier 140.

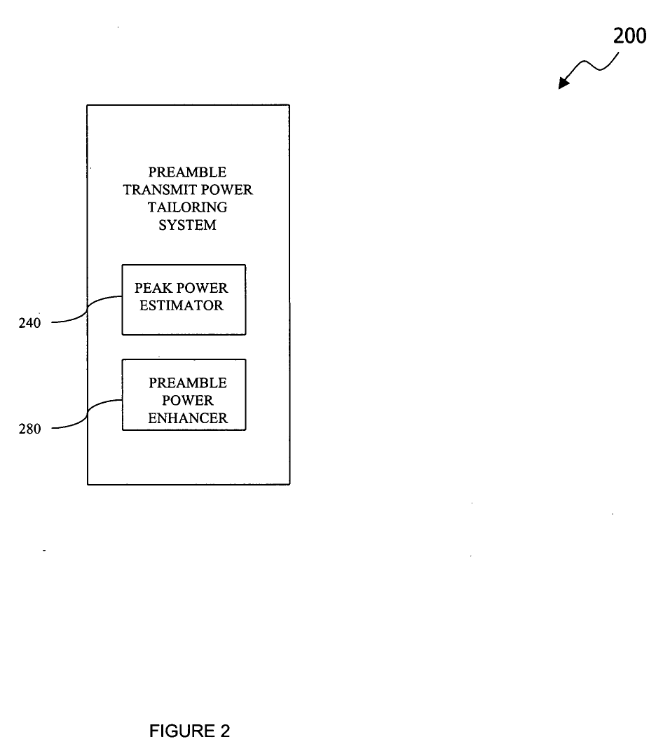

The preamble power enhancer 138, associated with the peak power estimator 134, is configured to increase transmit power of at least a portion of a preamble for the payload subject to the available power headroom. In some embodiments, the preamble power enhancer 138 may increase the transmit power for only a portion of the preamble. In other embodiments, the preamble power enhancer 138 may increase the transmit power for the entirety of the preamble. The preamble power enhancer 138 may determine the portion for the increase either statically or dynamically. The preamble power enhancer 138 may increase the preamble transmit power further subject to a maximum sufficient transmit value. The maximum sufficient transmit value may be a determined value related to a preamble transmitting power that provides a certain level of functionality associated therewith. In some embodiments, the maximum sufficient transmit value may be less than the transmit power limitation value. Thus, the transmitting power of the preamble can be increased to provide improved functionality at the receiver that is sufficient, for example, to provide channel estimation. The sufficient functionality can be provided without increasing the preamble transmit power to the full available power headroom. The peak power estimator 134 and the preamble power enhancer 138 will be discussed further with respect to FIG. 2.

The power amplifier 140 associated with the preamble transmit power tailoring system 130 may boost power of the payload for the wireless transmission over the channel. The power amplifier 140 may include components commonly employed within a conventional power amplifier of an OFDM transmitter. For example, the power amplifier 140 may include a backoff system.

Turning now to FIG. 2, illustrated is a block diagram of an embodiment of a preamble transmit power tailoring system, generally designated 200, constructed according to the principles of the present invention. The preamble transmit power tailoring system 200 includes a peak power estimator 240 and a preamble power enhancer 280. The peak power estimator 240 and the preamble power enhancer 280 may be embodied as a sequence of executable software instructions, dedicated hardware or a combination thereof. The peak power estimator 240 and the preamble power enhancer 280 may be employed within an ASIC or in a programmable device, such as an FPGA or a DSP.

The preamble transmit power tailoring system 200 may tailor a transmit power for a preamble to advantageously employ an available power headroom to allow a higher transmit power for the preamble. The higher transmit power may provide an improved functionality associated with the preamble. The preamble transmit power tailoring system 200 may be used with an OFDM transmitter. In some embodiments, the OFDM transmitter may be a SISO transmitter while in other embodiments the OFDM transmitter may be a MIMO transmitter.

The peak power estimator 240 may be configured to calculate, based on a payload to be transmitted by the OFDM transmitter and a transmit power limitation value thereof, an available power headroom. The peak power estimator 240 may determine a payload PAR to calculate the available power headroom. In some embodiments, the available power headroom may be a difference between the transmit power limitation value and a preamble PAR that is typically known (a typical preamble PAR). For example, the preamble PAR for a 802.11a system is typically low at about 3 dB. The peak power estimator 240 may determine the transmit power limitation value to be at about 10 dB. The peak power estimator 240 may calculate the available power headroom to have a value at about the difference, which is about 7 dB in this example. Of course in other embodiments, the difference between the known preamble PAR and the transmit power limitation value may be greater or less than about 7 dB. One skilled in the art will understand that the values of the known preamble PAR and the transmit power limitation value may differ from the values, 3 dB and 10 dB, used in this example. For example, the transmit power limitation value may vary based on the payload, or the payload PAR, and selected performance criterions.

In some embodiments, the peak power estimator 240 may dynamically determine the payload PAR. Dynamically determining the payload PAR may include measuring peaks associated with the payload while the OFDM transmitter is operating. In other embodiments, the peak power estimator 240 may determine the payload PAR statically. For example, the peak power estimator 240 may pre-determine the payload PAR offline based on statistics of common payloads. The peak power estimator 240 may also calculate the available power headroom based on a portion of the preamble. The portion of the preamble may be determined dynamically or statically, also.

The preamble power enhancer 280 associated with the peak power estimator, is configured to increase transmit power of at least a portion of a preamble for the payload subject to the available power headroom. Based on the above example, the preamble power enhancer 280 may increase the preamble transmit power about 7 dB. To insure that the transmit power limitation value is not violated, the preamble power enhancer 280 may increase the preamble transmit power about 6 dB over a typical preamble PAR. Thus, the preamble power enhancer 280 may not increase the preamble transmit power up to the full available power headroom.

The preamble power enhancer 280 may also be configured to increase the preamble transmit power subject to a maximum sufficient transmit value. Continuing the above example, study and observation may provide information that a preamble having a transmit power of about 8 db, typically a 5 db increase, may provide exemplary channel estimation. The preamble power enhancer 280, therefore, may transmit the preamble at about 8 dB instead of 9 dB which would save transmitting power and still provide desired functionality associated with the preamble.

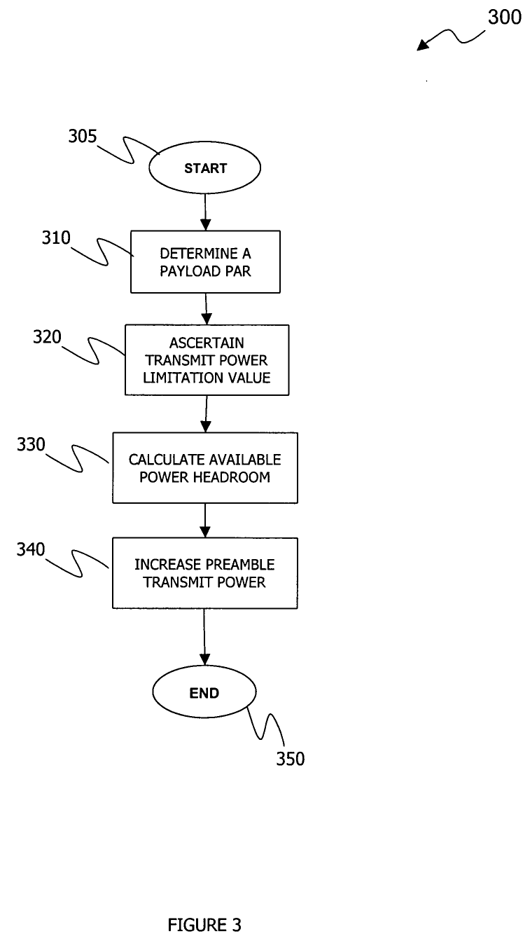

Turning now to FIG. 3, illustrated is an embodiment of a flow diagram for a method of tailoring preamble transmit power for use with an OFDM transmitter, generally designated 300, carried out according to the principles of the present invention. The method 300 is triggered by an intent to tailor preamble transmit power in a step 305.

After starting, a PAR of a payload to be transmitted by the OFDM transmitter is determined in a step 310. The payload PAR may be dynamically determined when the OFDM transmitter is online. In other embodiments, the payload PAR may be determined offline based on statistics of similar known payloads. In some embodiments, the OFDM transmitter may be a MIMO transmitter while in other embodiments the OFDM transmitter may be a SISO transmitter.

After determining the payload PAR, a transmit power limitation value is ascertained in a step 320. The transmit power limitation value may be ascertained based on the payload PAR and performance criteria of the OFDM transmitter. The transmit power limitation value may be determined packet-by-packet or determined at one time for a number of packets. Typically, the transmit power limitation value is a backoff value associated with the payload.

After ascertaining the transmit power limitation value, the available power headroom is calculated based on a preamble PAR and the transmit power limitation value in a step 330. The available power headroom may be calculated by subtracting the preamble PAR from the transmit power limitation value. In some embodiments, the preamble PAR may be a typical preamble PAR. The available power headroom may be calculated based on only a portion of the preamble.

After calculating the available power headroom, the method increases the transmit power for at least a portion of the preamble subject to the available power headroom in a step 340. The method 300 may increase the preamble transmit power to about the transmit power limitation value. In alternative embodiments, the method 300 may increase the preamble transmit power to a maximum sufficient transmit value. In some embodiments, the transmit power for the entirety of the preamble is increased. After increasing the preamble transmit power, the method ends in step 350.

While the methods disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order and/or the grouping of the steps are not limitations of the present invention.

Although the present invention has been described in detail, those skilled in the art should understand that they can make various changes, substitutions and alterations herein without departing from the spirit and scope of the invention in its broadest form.

1. For use with an Orthogonal Frequency Division Multiplexing (OFDM) transmitter, a preamble transmit power tailoring system, comprising:
a peak power estimator configured to calculate, based on a payload to be transmitted by said OFDM transmitter and an associated transmit power limitation value, an available power headroom; and
a preamble power enhancer, associated with said peak power estimator, configured to increase transmit power of at least a portion of a preamble for said payload subject to said available power headroom.

2. The system as recited in claim 1 wherein said transmit power limitation value is a backoff value.

3. The system as recited in claim 1 wherein said peak power estimator is further configured to calculate said available power headroom based on a peak-to-average power ratio (PAR) of said preamble.

4. The system as recited in claim 1 wherein said transmit power limitation value is based on a performance criterion and a PAR of said payload.

5. The system as recited in claim 1 wherein said peak power estimator dynamically determines a PAR of said payload.

6. The system as recited in claim 1 wherein said peak power estimator calculates said transmit power limitation value on a packet by packet basis.

7. The system as recited in claim 1 wherein said OFDM transmitter is a multiple-input, multiple output (MIMO) transmitter.

8. The system as recited in claim 1 wherein said available power headroom is based on said portion of said preamble.

9. The system as recited in claim 1 wherein said transmit power is increased for an entirety of said preamble.

10. The system as recited in claim 1 wherein said portion is determined dynamically or statically.

11. For use with an Orthogonal Frequency Division Multiplexing (OFDM) transmitter, a method of tailoring preamble transmit power, comprising:
calculating an available power headroom based on a payload to be transmitted by said OFDM transmitter and an associated transmit power limitation value; and
providing a transmit power for at least a portion of a preamble of said payload subject to said available power headroom.

12. The method as recited in claim 11 wherein said transmit power limitation value is a backoff value.

13. The method as recited in claim 11 wherein said calculating said available power headroom is further based on a peak-to-average power ratio (PAR) of said preamble.

14. The method as recited in claim 11 wherein said transmit power limitation value is based on a performance criterion and a PAR of said payload.

15. The method as recited in claim 11 further comprising dynamically determining a PAR of said payload.

16. The method as recited in claim 11 further comprising calculating said transmit power limitation value on a packet by packet basis.

17. The method as recited in claim 11 wherein said OFDM transmitter is a multiple-input, multiple output (MIMO) transmitter.

18. The method as recited in claim 11 wherein said calculating is based on said portion of said preamble.

19. The method as recited in claim 11 wherein said providing is for an entirety of said preamble.

20. The method as recited in claim 11 wherein said portion is determined dynamically or statically.

21. An Orthogonal Frequency Division Multiplexing (OFDM) transmitter, comprising:
a Forward Error Correction (FEC) coder that encodes a payload received by said OFDM transmitter;
OFDM transmission circuitry, coupled to said FEC coder, that processes said payload for transmission;
a power amplifier, coupled to said OFDM transmission circuitry, that boosts power of said payload for said wireless transmission over a channel; and
a preamble transmit power tailoring system associated with said power amplifier, including:
a peak power estimator configured to calculate, based on said payload and an associated transmit power limitation value, an available power headroom; and
a preamble power enhancer, associated with said peak power estimator, configured to increase transmit power of at least a portion of a preamble for said payload subject to said available power headroom.

22. The OFDM transmitter as recited in claim 21 wherein said transmit power limitation value is a backoff value.

23. The OFDM transmitter as recited in claim 21 wherein said peak power estimator is further configured to calculate said available power headroom based on a peak-to-average power ratio (PAR) of said preamble.

24. The OFDM transmitter as recited in claim 21 wherein said transmit power limitation value is based on a performance criterion and a PAR of said payload.

25. The OFDM transmitter as recited in claim 21 wherein said peak power estimator dynamically determines a PAR of said payload.

26. The OFDM transmitter as recited in claim 21 wherein said peak power estimator calculates said transmit power limitation value on a packet by packet basis.

27. The OFDM transmitter as recited in claim 21 wherein said OFDM transmitter is a multiple-input, multiple output (MIMO) transmitter.
